(19) United States
(12) Patent Application Publication
(10) Pub. No.: US 2022/0101245 A1
(43) Pub. Date: Mar. 31, 2022

(54) AUTOMATED COMPUTERIZED IDENTIFICATION OF ASSETS

(71) Applicant: International Business Machines Corporation, Armonk, NY (US)

(72) Inventors: Stan Kevin Daley, Atlanta, GA (US); Michael Bender, Rye Brook, NY (US); Gordan G. Greenlee, Endicott, NY (US); Tao Liu, Dublin, OH (US)

(21) Appl. No.: 17/035,754

(22) Filed: Sep. 29, 2020

(51) Int. Cl. G06Q 10/08; G06Q 30/00; G06Q 30/02; G06Q 30/06; G06F 16/28; G06F 16/953

(52) U.S. Cl. CPC G06Q 10/087; G06Q 30/0185; G06F 16/953; G06Q 30/0645; G06F 16/285; G06Q 30/0278

(57) ABSTRACT

Automatically detecting and cataloging items or assets at a location or property, using a computer, to capture, using multiple techniques and corresponding devices, data about an item of a plurality of items in a defined location, for cataloging the item. Using the computer to determine when the data meets threshold criteria for identification of the item and completing an identification of the item when the data meets the threshold criteria. Using the computer to determine when the item meets asset criteria for being cataloged as an asset, in response to the item meeting the threshold criteria for identification of the item and thereby the identification being completed. Metadata about the asset is gathered, in response to meeting the asset criteria, and the asset is cataloged with the data and the metadata.

### BACKGROUND

The present disclosure relates to computerized identification of assets, and more specifically, to automated computerized identification of assets at one or more locations and/or belonging to or owned by one or more entities or persons.

Items and assets in a location or items and assets in a person's house or office can be inventoried. Also, such items and assets can be assigned a value, individually, and cumulatively, which can be assessed. Inventorying items and assets can be accomplished manual, for example, a person itemizing and valuating assets using a computer by manually entering each item or asset into an electronic word processing, or spreadsheet, or another software program using a computer.

Typically, before assets can be valued, an inventory of those assets is created. A manual process can include entry of those assets into a system, but also can include entering information about the item into the system. For example, an entry can include entering a television, and as there are many different types of televisions, information about the television can then be entered such as model, type, date of purchase, size. Other examples include differences between a diamond and a cubic zirconia material, between a classic car and a jalopy, or a new car and a used car.

Such typical techniques of inventorying items or assets can be cumbersome, time consuming, and lack additional information about one or more items or assets.

### SUMMARY

The present disclosure recognizes the shortcomings and problems associated with current techniques for cataloging items or assets at a location or property.

The present invention recognizes the need for automatically detecting and cataloging item or assets at a location or property. The invention includes inventorying assets, which can be physical and/or digital assets, while capturing metadata about the asset which can make a more complete inventory and cataloging of assets and that will assist in valuing the asset. The present invention can enable multiple inputs to create an inventory via analysis of inputs, for example, video feeds, capturing unique identifiers of valuable items or assets, monitoring blockchains, and credit card bills and electronically capturing items on a local network. The present invention can also allow for the active loading of metadata on assets by scanning a barcode, such as quick response (QR) codes or other identifying features. Once the items or asset is identified, the present invention can enable the recording or collection of metadata about the asset.

In an aspect according to the present invention, a computer-implemented method for automatically detecting and cataloging items or assets at a location or property includes capturing, using a computer and using multiple techniques and corresponding devices, data about an item of a plurality of items in a defined location, for cataloging the item. The method includes determining, using the computer, when the data meets threshold criteria for identification of the item and completing an identification of the item when the data meets the threshold criteria. The method includes determining when the item meets asset criteria for being cataloged as an asset, in response to the item meeting the threshold criteria for identification of the item and thereby the identification being completed. Further, the method includes gathering metadata about the asset, in response to meeting the asset criteria, and cataloging the asset with the data and the metadata.

In a related aspect, the threshold criteria can include determining an identification of the item using the data.

In a related aspect, the threshold criteria can include a threshold probability of an identification of the item using the data, and the identification can occur in response to the threshold criteria being met based on the threshold probability being met.

In a related aspect, the method includes searching for and gathering the data and the metadata using a communications network, and wherein the searching for and the gathering the data and the metadata includes searching archive data and public data.

In a related aspect, the method includes reading a blockchain for the identified item to gather metadata about the identified item.

In a related aspect, the data can include a data input selected from a group consisting of: a video feed, a photo, manual entry including a keyboard input or a voice command audio input, as the multiple techniques and the corresponding devices.

In a related aspect, the multiple techniques and corresponding devices are selected from a group consisting of: video feeds, cameras, network inventory using network login, network inventory using Internet of Things (IoT), and computerized purchasing history.

In a related aspect, the asset criteria can include a valuation of the item and a threshold asset value.

In a related aspect, can include initiating other capturing techniques in response to the threshold criteria not being met.

In a related aspect, the method can further include initiating another capturing technique for capturing the data about the item, in response to the data not meeting the threshold criteria.

In a related aspect, the threshold criteria not being met includes being unable to identify the item.

In a related aspect, the method can include iteratively using another capturing technique until the data meets the threshold criteria for the identification of the item.

In a related aspect, the assets are physical and/or digital.

In a related aspect, the method can include assessing when an identified item is currently cataloged, and adding the metadata to the catalog about the currently cataloged identified item or the asset.

In a related aspect, the method can include assessing when an identified item is currently cataloged, and determining whether to add the identified item, in response to the identified item being currently cataloged.

In a related aspect, the method can include assessing a value of the asset using data and the metadata of the cataloged item or asset.

In a related aspect, the method can include detecting the item entering the defined location, and determining when the item meets the asset criteria by determining when an item meets a threshold value and thereby is an asset, in response to the identification of the item. Further, the method can include initiating the gathering of metadata, in response to the determining that the item meets the asset criteria for being cataloged as an asset.

In a related aspect, the threshold value includes determining when the item meets a minimal value.

In a related aspect, the determining when the item meets a minimal value includes checking a list of item categories for items meeting the asset criteria, and further comprises, receiving, at the computer, the list from a user; and cataloging the item as an asset, in response to the item matching a category in the list.

In a related aspect, the minimal value to the item can be sentimental or monetary.

In a related aspect, the method can include sending a communication to a user including an identified asset before the cataloging of the asset; and receiving authorization from the user to catalog the identified asset.

In a related aspect, the method can include sending a communication to a user which includes a first identified item or a first asset; and receiving notification from the user to mark or add an entry in the catalog as metadata about the first identified item or the first asset.

In a related aspect, the method can include receiving notification from the user to mark or add an entry in the catalog regarding the first identified item or the first asset as borrowed or as a temporary asset.

In another aspect according to the present invention, a system uses a computer for automatically detecting and cataloging items or assets at a location or property and includes a computer system. The computer system includes; a computer processor, a computer-readable storage medium, and program instructions stored on the computer-readable storage medium being executable by the processor, to cause the computer system to perform the following functions to; capture, using a computer and using multiple techniques and corresponding devices, data about an item of a plurality of items in a defined location, for cataloging the item; determine, using the computer, when the data meets threshold criteria for identification of the item and completing an identification of the item when the data meets the threshold criteria; determine when the item meets asset criteria for being cataloged as an asset, in response to the item meeting the threshold criteria for identification of the item and thereby the identification being completed; gather metadata about the asset, in response to meeting the asset criteria; and catalog the asset with the data and the metadata.

In another aspect according to the present invention, a computer program product for automatically detecting and cataloging items or assets at a location or property includes a computer readable storage medium having program instructions embodied therewith. The program instructions are executable by a computer to cause the computer to perform functions, by the computer, comprising the functions to: capture, using a computer and using multiple techniques and corresponding devices, data about an item of a plurality of items in a defined location, for cataloging the item; determine, using the computer, when the data meets threshold criteria for identification of the item and completing an identification of the item when the data meets the threshold criteria; determine when the item meets asset criteria for being cataloged as an asset, in response to the item meeting the threshold criteria for identification of the item and thereby the identification being completed; gather metadata about the asset, in response to meeting the asset criteria; and catalog the asset with the data and the metadata.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system, system features or components, and methodology for automatically detecting and cataloging items or assets at a location or property, according to an embodiment of the present disclosure.

FIG. 2 is a flow chart illustrating a method, implemented using the system shown in FIG. 1, for automatically detecting and cataloging items or assets at a location or property, according to an embodiment of the present disclosure.

FIG. 3 is a flow chart illustrating another method, implemented using the system shown in FIG. 1, for automatically detecting and cataloging items or assets at a location or property, according to an embodiment of the present disclosure.

FIG. 4 is a flow chart continuing from the flow chart shown in FIG. 3 depicting a continuation of the method shown in FIG. 3, according to an embodiment of the invention.

FIG. 5 is a functional schematic block diagram showing a series of operations and functional methodologies, for instructional purposes illustrating functional features of the present disclosure associated with the embodiments shown in the FIGS., for automatically detecting and cataloging items or assets at a location or property.

FIG. 6 is a schematic block diagram depicting a computer system according to an embodiment of the disclosure which may be incorporated, all or in part, in one or more computers or devices shown in FIG. 1, and cooperates with the systems and methods shown in the FIGS.

FIG. 7 is a schematic block diagram of a system depicting system components interconnected using a bus. The components for use, in all or in part, with the embodiments of the present disclosure, in accordance with one or more embodiments of the present disclosure.

FIG. 8 is a block diagram depicting a cloud computing environment according to an embodiment of the present invention.

FIG. 9 is a block diagram depicting abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

As used herein, an item can include any object or thing which can have a value. A value can be monetary or sentimental or both. A valuable item is defined herein as an asset. Additionally, an inventory is used synonymously with cataloging as being defined as a list of items such as property, or contents at a location, and the process of creating metadata can represent information about the items, for example, such information can include defining the item as a book, sound recording, or video and providing information about these items such as creator names, titles, and dates, etc. Or, in another example, a method and system can include inventorying a purchased item and cataloging the item and metadata about the item such as date, manufacturer, model, serial number, type, product, where purchased, etc.

### Embodiments and Examples

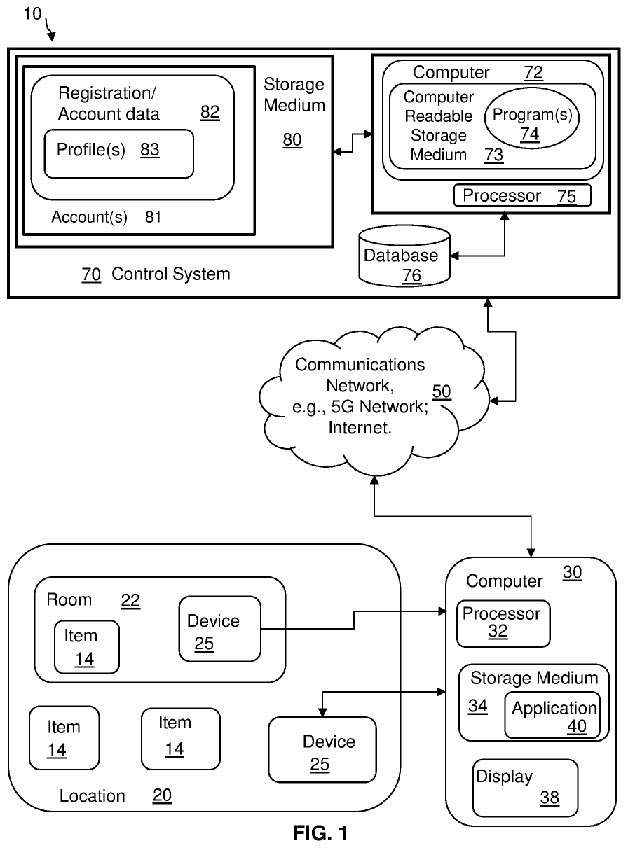

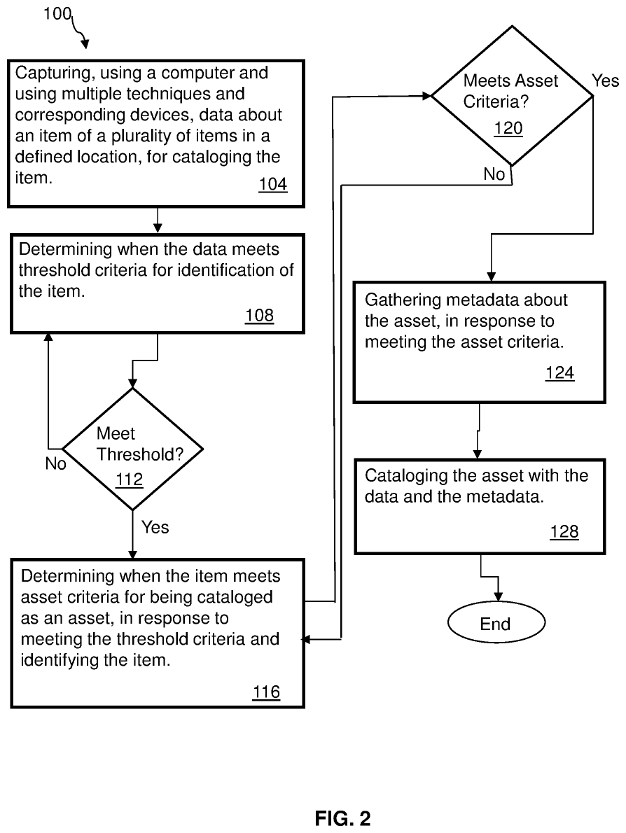

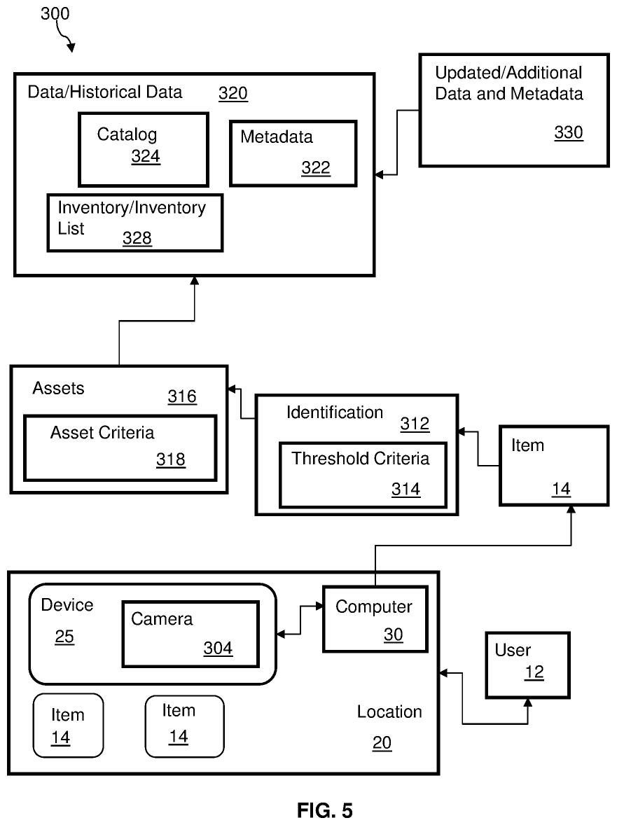

Referring to FIGS. 1 and 2, a computer-implemented method 100 for automatically detecting and cataloging items or assets at a location or property includes a series of operational blocks for implementing an embodiment according to the present disclosure. The method 100 according to an embodiment of the present disclosure includes capturing, using a computer 30 and using multiple techniques and corresponding devices, data 320 (FIG. 5) about an item of a plurality of items 14 in a defined location, as in block 104. The capturing of the data 320 is for cataloging the item or items in a catalog 324 (FIG. 5), as also in block 104. Such cataloging and the catalog 324 (see FIG. 5) can also be referred to as inventorying and an inventory 328 or an inventory list. The catalog 324 and/or inventory 328 (or inventory list) can be stored as historical data 320 on a computer readable storage media.

The capturing can include a computer such as a system computer for implementing and maintaining an inventory list or catalog communicating with a technique and corresponding device. For example, techniques and corresponding devices can include a video feed can use a video camera 304 (see FIG. 5), as a device, for capturing video of items as they enter the location 20 or to scan a room 22 at the location, such as a home or an office to determine if a new item is present at the location. For example, the system can detect a television entering the location, or detect a television at the location which when compared to a catalog or an inventory list is not in the inventory list or catalog and thus is determined to be new. The system can capture not only the item itself, but may be able to capture a model number, or serial number, and enter this additional information or metadata into the inventory or catalog, as will be discussed in more detail below.

Additionally, the method and system is discussed with reference to FIG. 5, which is a functional system 300 which includes components and operations for embodiments according to the present disclosure, and is used herein for reference when describing the methods and systems of the present disclosure. Additionally, the functional system 300, according to an embodiment of the present disclosure, depicts functional operation indicative of the embodiments discussed herein.

For example, as shown in FIG. 1, one or more items 14 are shown as representative of a plurality of items 14. One or more devices 25 are shown as representative of a plurality of devices 25. The devices 25 are communicating with a computer 30. The computer can be at the location 20, remote from the location, or part of a mobile device, for example, a mobile device belonging to a user 12 (FIG. 5). The devices 25 correspond to one or more techniques for gathering data. For instance, a device can include a video feed or camera (for example, camera 304 (FIG. 5)). The computer 30 includes a processor 32 and a storage medium 34 which can include an application 40 embodying the method of the present disclosure. The computer 30 further including the processor 32 for executing the application/software. The computer 30 can communicate with a communications network 50, e.g., the Internet. The devices 25 can also communicate with the communications network 50, e.g., the Internet, directly or through the computer 30 for gathering data and storing the data or historical data 320.

The catalog 324 or inventory list 328 can be stored on the computer 30 as historical data 320, for example on the storage medium 34. The historical data can also be stored remotely, for example, on a remote server, for instance, a remote storage medium 73 or a database 76. The items 14 can include physical items, and can also include digital items which can be captured using computer access to charge card accounts or a bank account. In this example, the computer can detect a new purchase, recognize as an asset, and search for more information or metadata about the asset, as described below in more detail. The inventory and/or catalog can be used for assessing a value of the asset, which in turn can be used for cumulative valuation, or an insurance claims, or for replacement of items.

Continuing with reference to FIGS. 1 and 2, the method 100 includes determining when the data meets threshold criteria 314 for identification 312 of the item, as in block 108. In one example, the threshold criteria can include determining a positive identification of an item, for example, being able to identify the item definitively such as a television or a computer. When the method cannot make a positive identification, for example, the method cannot determine what the item is, or make a positive identification of the item, as in block 112, the method can return to block 108. In another example, a probability threshold can be determined of a possible or probable identification, such as a probability that an item is a television. When a probability threshold is met, as in block 112, for example, the method determines that it is more likely than not that the item is positively identified, for example, the method can determine that the item is more likely than not a television. When the method determines that a threshold is met, the method can continue to block 116.

The method 100 includes determining when the item 14 meets asset criteria 318 for being cataloged as an asset 316, in response to meeting the threshold criteria and identifying the item, as in block 116. When an item has been identified, the method determines whether that item is of negligible value or not an item for inventorying or cataloging, or meets an asset criteria for being cataloged or inventoried as an asset, that is, an item of value to the user. For example, a user can enter categories or specific items that are of value to a list of items for comparison and matching by the method as part of the asset criteria to determine whether the item should be classified as an asset. In another example, the method can determine whether the item meets an asset criteria which can include determining if the asset has a minimal value or a specified value, or is an item matching an item on an asset list which can list types of assets for cataloging, such as televisions, computer, electronics, etc.

As discussed above, the method can include asset criteria which includes a valuation of the item and a threshold asset value. For example, regarding valuation, asset criterion can include a criterion that the item has a specified monetary value, or in another example, be worth more than a specified monetary value. In another example, the criterion can be that the item be part of a category, such as electronics or entertainment system, or in another example, several categories can be included as assets and one or more other categories can be included as non-assets, such as groceries, food, or perishables.

The method 100 includes gathering metadata 322 (FIG. 5) about the asset, in response to meeting the asset criteria, as in block 124. For example, the method can use a video feed to detect distinguishing features and data of the item. For instance, a type of electronic device, a model number or serial number. The method and system can access billing record, a bank account for a purchase history, smart phone photos or purchase history using a smart phone. In one example, the user can update a photo, and/or information about an item for cataloging and/or as metadata to be associated with the item for cataloging purposes. In another example, Internet of Things (IoT) devices can be used to gather information regard an item/asset such as model and serial numbers.

The method 100 includes cataloging the asset with the data and the metadata, as in block 128. For example, the identified item/asset can be entered into a catalog with the metadata, for example, any additional information or additional data or metadata 330 regarding the asset.

Thereby, the present disclosure provides a method and system to automatically build an asset inventory using in one example an image of the asset, for example, images can include a code, serial number, model number, or product number. Further the method and system of the present disclosure include populating a catalog with metadata about the asset. Although embodiments of the present disclosure can be used to value an asset by using the data and metadata gathered, cameras can be used to do comparisons of a location at different times to identify changes or to capture unique identifying information. Embodiments of the present disclosure can gather data by digesting data from blockchains, receipts, and network to identify items/assets, and can identify potential duplicates while capturing additional metadata available from the different sources. Embodiments of the present disclosure can also use temporal impacts so as not to continually add and remove items from an inventory.

Embodiments of the present disclosure includes using a plurality of feeds from blockchains, receipts, automated area images compared to previous images, connections to network devices to identify assets to track as part of an inventory. Assets can be identified that were loaded from more than one of the sources to eliminate possible double counting of an asset. Identifying data can be used to supplement the available metadata by going to publicly available or personal repositories that contain additional information that can be used in valuing an asset.

One advantage of the method according to the present invention includes cataloging assets for future reference which can include valuating the assets individually or in total. Such valuation can be used for insurance purposes such as providing an accurate inventory for valuation to an insurance company, or likewise for distribution of property in an estate sale, or assessing value of an estate or part of an estate for sale of items or for assessing the value of all or part of the assets of an estate, a person's property.

In one example, threshold criteria can include an identification of an item. For example, identifying an item can meet a threshold criterion or criteria. Thereby, in one example, a threshold criterion or criteria is met in response to an identification of an item.

In another example, a threshold criterion or criteria can include a threshold probability of an identification of an item, and the identification can occur in response to the threshold criterion or criteria being met based on the threshold probability being met. For example, the method and system of the present disclosure can determine that the probability is more likely than not, that is more than fifty percent likely, that an item is identified. For example, determining that an item more likely than not identified as a television rather than a computer monitor, and in response, determining that a threshold criterion or criteria is met and indicating that an item is identified or positively identified, for example, as a television.

In another example, the method according to the present disclosure can include searching for and gathering the data and the metadata using a communications network. The metadata can include additional information about the data and thereby the item.

In another example, searching for and the gathering the data and the metadata includes searching archive data. For example, archive data can be, at least in part, data and metadata about items and assets which is stored for access by the method(s) of the present disclosure. Such data can include information about one or more items which were identified by the method and system.

In one example, a method and system according to the present invention can include reading a blockchain for the identified item/asset to gather metadata about the identified item/asset.

In another example, the data can include data input selected from a group consisting of: a video feed, a photo, manual entry including a keyboard input or a voice command audio input, as the multiple techniques and the corresponding devices.

The method of claim 1, wherein the multiple techniques and corresponding devices are selected from a group consisting of: video feeds, cameras, network inventory using network login, network inventory using Internet of Things (IoT), and computerized purchasing history. For example, a technique can include a video feed and the corresponding device can include one or more cameras. In another example, a technique can include communications between devices and a corresponding device can include one or more IoT devices. Such communications, searching and gathering of data and metadata can include using the Internet. In another example, additional data can be found and collected as a result of manual input from a user wherein the user can input data such as product information and/or upload receipts.

In another example, the systems and methods according to the present disclosure can include storing the data and the metadata, using the computer, about the item(s) and asset(s) on a computer readable storage medium. In one example, the computer storage medium can include a server such as a directory server, for example a local server or a remote server or database 76.

In one example, the method can include initiating other capturing techniques in response to the threshold criteria not being met. For instance, in response to an identification of an item not being completed or no identification being completed, the method can initiate other or additional data capturing techniques. Such additional capturing techniques can include additional cameras or video feeds, other scanning techniques, saved data, electronic credit card invoices or bank statements, or IoT devices. In one example, the method includes initiating another capturing technique for capturing the data about the asset, in response to the data not meeting the threshold criteria. In one example, the threshold criteria not being met includes being unable to identify the item.

In one example, the method can include iteratively using other capturing technique until the data meets the threshold criteria for identifying the item.

In another example, the item and/or assets can be physical and/or digital. For example, physical items/assets can include electronic items, such as computers or televisions, or smart devices. Digital items can include software, and/or applications. Such digital items can be detected when an item is online and accesses the digital item/resource using the network, and/or a digital download can be detected and identified. And, the item can be detected by accessing digital data/information about digital items, such as electronic receipts and invoicing.

In another example, the method can further include assessing when an identified item is currently cataloged and adding the meta data to the currently cataloged identified item. In another example, the method can further include assessing when an identified item is currently cataloged, and determining whether to add the identified item, in response to the identified item being currently cataloged.

In another example, a value of the asset can be assessed using data and the metadata of the cataloged asset. In another example, the method can include providing the cataloged data and the metadata about the identified asset/item to a tracking database for locating identified assets not at the defined location.

In another example, the method can include detecting the item entering the defined location; determining when the item meets the asset criteria by determining when an item meets a threshold value and thereby is an asset, in response to the identification of the item; and initiating the gathering of metadata, in response to the determining that the item meets the asset criteria for being cataloged as an asset.

In another example, the threshold value can include determining when the item meets a minimal value, and the determining when the item meets a minimal value includes checking a list of item categories for items meeting the asset criteria. The method can further include receiving, at the computer, the list from a user, and cataloging and/or labeling the item as an asset, in response to the item matching a category in the list. In one example, the asset criteria for the item can include assessing a minimal value to the item. In one example, the minimal value to the item can be sentimental or monetary. For example, a monetary value can be assessed or a sentimental value can be inputted by a user.

In one example, the method can include sending a communication to a user including an identified asset before the cataloging of the asset, and receiving authorization from the user to catalog the identified asset. In another example, the method can include sending a communication to a user including an identified asset, and receiving notification from the user to mark or add an entry in the cataloging as metadata about the identified asset. In a further example, the method can include receiving notification from the user to mark or add an entry in the catalog regarding the first identified asset as borrowed or as a temporary asset.

### Other Embodiments and Examples

Referring to FIGS. 1, 3 and 4, in one embodiment according to the present disclosure, a computer-implemented method 200 for automatically detecting and cataloging items or assets at a location or property, and/or having a defined ownership. The method includes populating and maintain a historical database of items in a defined location and/or having a defined ownership, as in block 202. In one example, a historical database can include database 76 which can be populated with historical data of item and assets in one or more locations and/or being defined as belonging to one or more owners. For example, an item can be defined as an asset situated or located at a location or belonging or owned by a particular person. In one example, an owner can maintain items and assets at several location, such inventorying of assets can include gathering or information regarding the assets from multiple sources/locations and saving the information or asset data in the historical database.

The method includes capturing, using a computer and using multiple techniques and corresponding devices, data about an item of a plurality of items in a defined location, as in block 204, for cataloging the item. In one example, the method and system can detect the item entering the defined location.

The method 200 includes determining when the data meets threshold criteria for identification of the item and completing an identification of the item when the data meets the threshold criteria, as in block 208, thereby identifying the item. In one example, when the data meets the threshold criteria for identification of the item, an identification of the item is made, or this can be called a positive identification of the item. Subsequently, the method can search for and gather additional data and metadata using a communications network.

The method includes achieving an identification of the item, as in block 212. In one example, threshold criteria can include achieving an identification of the item. For example, a video feed may lack resolution to complete an identification of an item, and thus an identification cannot be achieved and the threshold criteria is not met. In another example, the threshold criteria can include a level of resolution for a video feed or a photo. In another example, threshold criteria can include a level of confidence in an identification of an item, for instance, the level of confidence being higher than fifty percent, or more likely than not, that an item is positively identified, can result in meeting the threshold criteria.

The method includes initiating another capturing technique in response to the threshold criteria not being met, as in block 216. For example, when threshold criteria is not met, for instance the method and system cannot identify the item, one or more capturing techniques can be initiated for identifying the item. For example, another video feed can be initiated, and/or posted photos. In another example, data retrieval can be initiated such as purchase records, credit card records or bank account records. Such records can be used to identify the item as a purchased item. In another example, additional capturing techniques can be initiated, in response to the data not meeting the threshold criteria.

The method includes iteratively using another capturing technique until the data meets the threshold criteria for the asset, as in block 220. For example, other capturing technique and/or re-initiating capturing techniques until the threshold criteria for the item is met, and thus the item is identified, or in other words, a positive identification of the item is achieved.

The method includes determining when the item meets asset criteria for being cataloged as an asset, in response to meeting the threshold criteria and identifying the item, as in block 224. For example, once the item is identified, that is, meets the threshold criteria and a positive identification of the item is achieved, the method can continue to determine when the now identified item meets the asset criteria. For example, the asset criteria may include determining when an item meets a certain or minimal value, that is, is more than typical household items. Or, in another example, the asset criteria may include determining when the item is not a typical household item, and thus it can be concluded that the item has value which can be monetary or sentimental and thus should be defined as an asset and cataloged. Thus, in one example the method includes determining when the item meets the asset criteria by determining when an item meets a threshold value and thereby is an asset, in response to the identification of the item.

The method includes, initiating the gathering of metadata, in response to the determining that the item meets the asset criteria for being cataloged as an asset, as in block 228.

The method includes, gathering metadata about the asset, in response to meeting the asset criteria, as in block 232. For example, the method can search for and gather the data and the metadata using a communications network. For example, metadata can include data about the data, for instance, metadata can include a receipt for an identified item, or a model number or serial number for an identified item.

The method includes, cataloging the asset with the data and the metadata, as in block 236. For example, a catalogue can include the item, that is an identification of the item, for instance, a flat screen television, the catalog can additionally include data about the item and metadata, for instance, a flat screen television, a dimension of the television, and the metadata can include a model number, a serial number, etc.

The method can include, assessing when an identified item is currently cataloged, as in block 240. For example, the method can determine when an item is cataloged and/or inventoried but checking the catalog or inventory for the item that is identified. In one example, an item or asset may have been moved from one room to another at a location, or taken off premises and brought back on premises. In a situation as this, the method can check when the item is already cataloged. When the item is already cataloged, additional metadata, if available, can be added without double inventorying the item. The method can include, adding the metadata to the currently cataloged identified item, as in block 244.

The method can include, communicating with a user to ask whether to add an item, in response to a duplicate item being detected, as in block 248. For example, when a duplicate item is detected, that is, an item is identified and recognized as already in the catalog, the method can communicate to a user that an item is detected and already in the catalog, and request the user to authorize an action. For instance, the action can include entering the item in the catalog, or not doing anything with the identified item. The communication can use the communications network and can be an electronic communication such as a text or an email. The method and system can receive an authorization from the user to complete the action. In another example, the method and system can generate a communication to the user asking whether to add an identified item which has already been detected as in the catalog. And the method and system can receive authorization from the user answering the question to add the identified item as a separate item or to ignore the identified item (as already cataloged).

The method can include providing the cataloged data and the metadata about the identified asset/item to a tracking database for locating identified assets not at the defined location. For example, the tracking database can be associated with the historical data such that the historical data s supplied to the tracking database for locating missing assets.

In one example, the threshold value includes determining when the item meets a minimal value, wherein the value can be a monetary value and/or a sentimental value. In one example, the determining when the item meets a minimal value can include checking a list of item categories for items meeting the asset criteria, and further can include receiving, at the computer, the list from a user. The method can further include cataloging (or alternatively, labeling) the item as an asset, in response to the item matching a category in the list. In one example, the asset criteria for the item can include assessing a minimal value to the item. For example, the minimal value associated or assigned to the item can be sentimental and/or monetary.

The method can include sending a communication to a user including an identified asset before the cataloging of the asset. The communication can be an electronic message such as an email or a text message, and the message can include the identified asset. The method can include receiving authorization from the user to catalog the identified asset. For example, the user can reply to the communication authorizing cataloging of the assets. In another example, the user can reply to the communication to not catalog the asset, for example, if the user believes the asset to be of too little value, or to be a duplicate, or not an asset for cataloging, for instance, a borrowed asset.

In another example, an asset identified as borrowed, by communication of a user, or by the method and system determining that a visitor to the location brought the item into the location or the item is a possession of the visitor, can be cataloged as borrowed or as a temporary asset.

In another example, the method can include sending a communication to a user including an identified asset, and receiving notification from the user to mark or add an entry in the cataloging as metadata about the identified asset. In one instance, the identified asset can be marked as borrowed or a temporary asset. The identified asset can be marked as borrowed or a temporary asset, as discussed above.

In one example, a user can register an account which can include one or more profiles 83 as part of registration and/or account data 82. The registration can include profiles for each user having personalized data. For example, users can register using a website via their computer and GUI (Graphical User Interface) interface. The registration or account data 82 can include profiles 83 for an account 81 for each user. Such accounts can be stored on a control system 70, which can also include a database 76 for data storage.

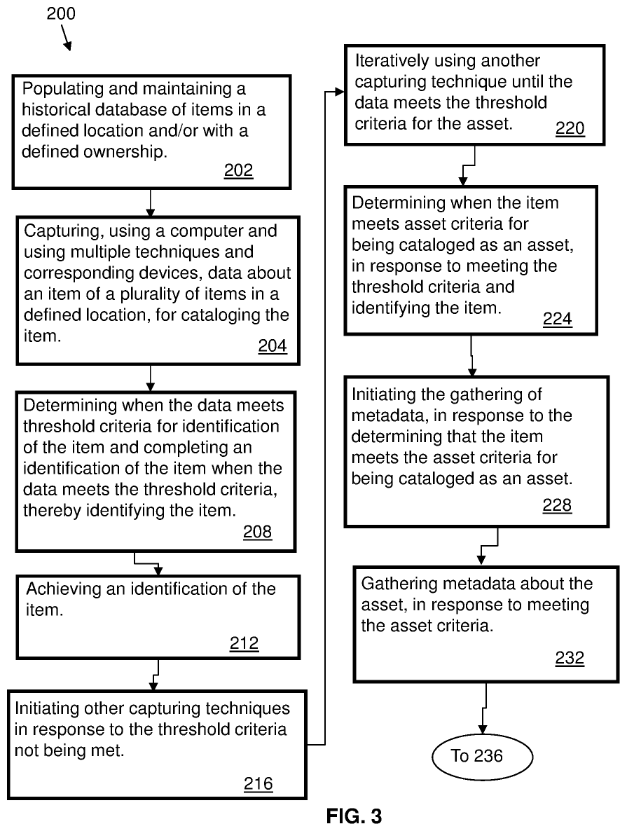

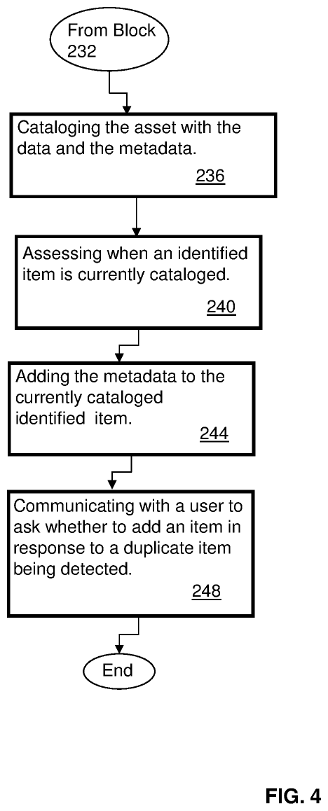

Operational blocks of the method 200 shown in FIGS. 3 and 4 may be similar to operational block shown in FIG. 2. The method shown in FIGS. 3 and 4 is intended as another example embodiment which can include aspects/operations shown and discussed previously in the present disclosure.

### Further Embodiments and Examples

Embodiments according to the present disclosure can includes a system and method for automatically detecting and cataloging items or assets at a location or property. The systems and methods of the present disclosure includes inventorying assets so that assets can be valued. The systems and methods can include automatically capturing items and assets for identification of the assets and entry of assets into an inventory system, and capturing and gathering information about the assets once the assets are identified. Such information can include, for example, a make, model, type, size, serial number, product number, etc. And, such information can be used in valuation of assets.

Systems and methods according to the present disclosure include a method for assets, including physical assets, to be inventoried while capturing critical metadata about the asset that can assist in valuing the asset. Multiple inputs can automatically and without a person's manual input, create an inventory via analysis of video feeds, capturing unique identifiers of high value items, monitoring blockchains and credit card bills and electronically capturing items on a local network. Metadata about assets can also be active loaded by scanning QR (Quick Response) codes or other identifying features. Once the items are captured, these feeds can also enable recording of metadata about the item.

In one example, a system and method according to the present disclosure can passively update an inventory of physical assets and/or respective metadata via, for example, image analysis of a new inventory item actively scanned; accessing blockchains with new assets; manually scanning new items (e.g., QR code, bar codes); identifying assets linked to a network; comparing different point in time images of a location for additions and deletions, and comparing them to catalogs or web pages to identify the product (e.g., a specific television). An inventory can be saved in a blockchain so that irrefutable evidence of when assets were added or removed Is saved. This disclosure is a novel method of capturing inventory. In other embodiments, this disclosure can be used to produce list of missing or stolen item for insurance or police reports, while identifying the time the asset was determined to be missing. For unique items, the disposition of the asset can also be tracked when its possession is inappropriately transferred to an innocent party.

In one example, a method can include capturing items with unique serial number identifications to update an inventory. Such a method can include a camera capturing images of serial number via analysis of an image. The camera can send a serial number to a system or control system for the method embodied as a software application. The system can look up metadata in a catalog about the item. The method can include reading a blockchain to identify assets transferred to or away from an individual. Information from the blockchain can update ownership and metadata about the item. Such a methodology can be used for a higher valued item (e.g., an automobile).

In one example, a method in accordance with the present disclosure can use image analysis to identify additions/removals of assets and can include, before and after images being compared. Differences in the images can be identified and images of the new or removed items can be sent to the system. Based on an inventory of images, the system can identify the items that have been added or removed, and the system can update the inventory including the appropriate metadata. The method can actively or passively capture unique identifiers via scanning of code to update inventory. One or more cameras can capture the image of a bar code or QR code, for example, a Vehicle Identification Number (VIN) of a car. The system can recognize the identifier using the code, e.g., VIN. The system can look up asset metadata with the identifier from a public/private catalog, including a brand, a make, a model year, and for a car a vehicle accident report, etc. The method can actively or passively capture unique identifiers via scanning of network connectivity for connected assets. The system can scan a WIFI network to find identifiers of connected devices, for example, a MAC (Media Access Control) address. The system can look up asset metadata with the identifier from a public/private catalog.

In another example, a method and system according to the present disclosure can cross reference an item such as a diamond ring purchase when a user uses their smart phone to look at the diamond or take a photo. The system can enter metadata about the item, such as quality, clarity, size and color for the example of a diamond. In another example, for a car purchase, the system can use the auto manufacturers blockchain to add the car to the users assets without any interaction needed. In another example, a user can buy a new smart phone and when the new smart phone is recognized on the network, the system captures the International Mobile Equipment Identity (IMEI) using the network to capture the brand and model of the phone. The system can ask the user to validate the purchase of the phone. In other examples, an item purchased by a user can be recognized by the system and added to an inventory with metadata from a receipt. Such receipt information can be gathered from a credit card entry or a smart phone photo. In another example, cameras in a house can detect and capture image changes from a previous scan, the item can be identified using image analysis, and the item can be added to inventory. Thereby, the methods and systems of the present disclosure include a method to passively generate or supplement a person's inventory of owned items by analyzing multiple feeds to create a trusted inventory source.

Methods and systems of the present disclosure include a computer enabled method of managing an inventory of items, for example physical items, in a location. The methods and systems include creating a storage location for an inventory, and registering devices and locations that can update that inventory. Further, the method and system includes identifying changes to the inventory, and storing the inventory changes in an irrefutable location. A storage location can be a blockchain. Access to devices and databases can be used in identifying inventory changes. The methods and systems can include identifying changes by scanning in unique serial numbers, and capturing metadata based on the unique serial number. In another example, the methods and systems can include reading another blockchain to identify changes to assets. The methods and systems can include utilizing IoT devices to capture images of a location that stores inventory. In another example the method and system can include comparing the inventory at one time, using a time stamp, to a new image via cognitive analysis of the image. In another example, the methods and systems can include searching reference databases to identify added or removed inventory items based on image comparison. In another example, a person can modify the inventory based on the highlighted inventory differences. In another example, inventory can be added based on assets identified via being connected to a network. In yet another example, a blockchain can be utilized to store the modifications to the inventory.

In one example according to the methods and systems of the present disclosure, items can be brought into a location as the result of a purchase, gift, inheritance, another individual who has not given up custody of an item, or a borrow. The assets, including physical assets, can be tracked with the exception of an item in the house that is in the custody of another. Borrowed items can be listed while under the custodial care of another based on the responsibilities attached to the custodianship of the borrowed item.

In another example, the invention can also allow individuals or entities to exclude items from being stored in an inventory. For example, items may be declined or excluded for low value (e.g., typical household item such as a box of tissues) or consumables such as food (e.g., a box of cereal). In another example an item can be declined or excluded from inventory as a temporal item (e.g., an item that is transitory and not a part of the true inventory), or as part of a defined exclusion list. Items can include furniture and clothing, unless excluded, as tracking full inventory for such items as net worth or insurability.

In another example, when an item was brought into a location such as a house, there can be items which are not confirmed as assets to be captured and cataloged. Without confirmation, these items can be captured by the system and cataloged, and the item can be validated later, for example via a user interface that the item is such that it should be included in the inventory.

In another example, reconciling between the multiple silent methods as to prevent double counting can be determined and executing. In one example, any conflicts in the metadata can be configured such that a notarized letter from a trusted source would have priority over other authentication methods. A wi-fi identified device can have priority over a blockchain. A blockchain from a manufacturer can have priority over image data. In another example, an image with a model/serial number can have priority over a receipt. A receipt can have priority over a generic image, and an image can have priority over manually entered data.

In one embodiment, the present disclosure can capture data within the capabilities of the system. For example, the methods and system according to the present disclosure can include identifying blockchains to monitor for high-value items (e.g., cars, jewelry). Access can be provided to credit card receipts, online purchases or other activities to identify new purchases. Access can be provided to IoT enabled cameras for image analysis inside a defined geo-fence for monitoring. Further, access can be provided to a Wi-Fi router to determine devices connected to the network.

In another example, embodiments of the present disclosure can include providing a secure user interface to scan bar codes or manually enter additions or deletions, by individuals authorized to provide updates to the inventory. In addition, the user interface can be used to reconcile potential duplicate counted items or items that cannot be identified by the system. Non-identifiable items can be used as training data for future scans of similar items. Access to the inventory can be provided to individuals or entities authorized to read the blockchain of the final inventory changes. In another example, a system can be enabled to provide additions to the blockchain.

In one example, a method to identify items with a unique serial number can include loading the system with information about items that have unique serial numbers which can be used to complete the metadata about the item to facilitate determining a value. A serial number on a diamond or a vehicle identification number on a car are examples of items where loading via serial number can be implemented. In another example, a user can take a picture of an item (which can be stored in the blockchain as it helps identify the item and also shows the state of an item). In another example, a user can take a picture of the serial number, or a user can load the data into the system. An image analysis can determine which sources to cross reference to obtain the metadata (e.g., a picture of a car would not cross reference a diamond database or blockchain). If cross referencing is not found, a serial number would not be used for metadata but image analysis and other sources (e.g., receipts, type/model) can be used. If an item is found, the system can check if the item is loaded and append the additional information to the item record, or create a new record if there is no item record. If the system recognizes that the item identification is outside a sufficient level of confidence, the system can request a user to validate if the item is one of a plurality of items that may have been a match. Such a technique can also be used if the metadata conflicts with existing metadata about the state of the object.

In another example, a method and system according the present disclosure can read a blockchain to identify assets transferred to or away form a user. Items can be updated where there is an outside record demonstrating that the asset has been transferred. Registered blockchains can be scanned for updates related to transferring ownership of an item to or from an individual. If an item is found, the system can check if the item is loaded, and if so, the system can append the additional information to the item record. If an item is not found, the system can create a new record. If outside a sufficient level of confidence, the system can ask a user to validate if the item is one of a plurality of items that may have been a match or if the metadata conflicts with existing metadata about the state of the object. Registered blockchains can be scanned for updates related to state changes of items for items related to an individual (e.g., an insurance blockchain notes that the car was in an accident or had items added to it). If an item is found, the system will check if the item is loaded. If loaded, the system can append the additional information to the item record. If not loaded, the system can create a new record. If outside a sufficient level of confidence, the system will ask a user to validate if the item is one of a plurality of items that may have been a match or if the metadata conflicts with existing metadata about the state of the object.

In another example, a method and system can include use an image analysis to identify additions and removals of assets. Temporal and value limits can be used in determining changes to the inventory. In one example, before and after images are compared, and differences in images are used to determine additions and deletions. Additional items are compared to exclusion limits to determine if they should be loaded. If items are on an exclusion list, comparison can stop for the item. Additional items can be compared to temporal limits. If an item is under the temporal limit, it can be compared to an appropriate image that meets the temporal limit or stored in a temporary staging database for the appropriate amount of time. If the item meets a change criteria, the inventory can be updated. The inventory record can be loaded with the image, and the image cross referenced against web sites to identify the object where appropriate. If a change can't be identified, the item can be queued for review in, and a user or approver can be notified that a reconciliation is required.

In another example, a method and system can actively or passively capture unique identifiers which can be used to identify items that have images with unique identifier (e.g., television model/serial no.) or are inputted or fed from a system that has a unique identifier (e.g., credit card receipt or bill). The System can capture images of barcodes to identify an item. The system can capture information about unique identifiers from a system-linked feed (e.g., credit card). If an item is on an exclusion list, it can be ignored. The system can look up additional data from public private sources related to the product category, and the system can use provided information to gather additional metadata to store in inventory. If an item is not found, it goes into a review queue. The system can determine if an item is already loaded and an inventory needs updating.

In another example, a system and method can capture unique identifiers via a scanning network, to identify additions/deletions to the network based on connectivity. Temporal limits can be used to identify items that have a high probability of belonging to another individual. The system can use a Wi-Fi network to find an identifier of connected devices (e.g. MAC (media access control) address). The system can look up an asset via the metadata for public/private catalogs (e.g., phone brand and model). The system can determine if the item has been on the network for a sufficient amount of time. If the item has been on the network, it can be added to the inventory, if it is not, it can be presented for validation by a user as belonging to the inventory or excluded. If updates to the inventory are required, use rules can be implemented to update the inventory. In another embodiment, if sufficient removals of inventory have occurred in a limited amount of time, this can be in initiated by a user or in response to questions presented to the user.

Although embodiments of the present disclosure can be used to value an asset by using the data and metadata gathered, cameras can be used to do comparisons of a location at different times to identify changes or to capture unique identifying information. Embodiments of the present disclosure gathers data by digesting data from blockchains, receipts, and network to identify items, and identifies potential duplicates while capturing additional metadata available from the different sources. Embodiments of the present disclosure also use temporal impacts so as not to continually add and remove items from an inventory.

Embodiments of the present disclosure includes using a plurality of feeds from blockchains, receipts, automated area images compared to previous images, connections to network devices to identify assets to track as part of an inventory. Assets are identified that were loaded from more than one of the sources to eliminate possible double counting of an asset. Identifying data can be used to supplement the available metadata by going to publicly available or personal repositories that contain additional information that can be used in valuing an asset.

Account data, for instance, including profile data related to a user, and any data, personal or otherwise, can be collected and stored, for example, in the control system 70. It is understood that such data collection is done with the knowledge and consent of a user, and stored to preserve privacy, which is discussed in more detail below. Such data can include personal data, and data regarding personal items.

In one example a user can register 82 have an account 81 with a user profile 83 on a control system 70, which is discussed in more detail below. For example, data can be collected using techniques as discussed above, for example, using cameras, and data can be uploaded to a user profile by the user.

### More Examples and Embodiments

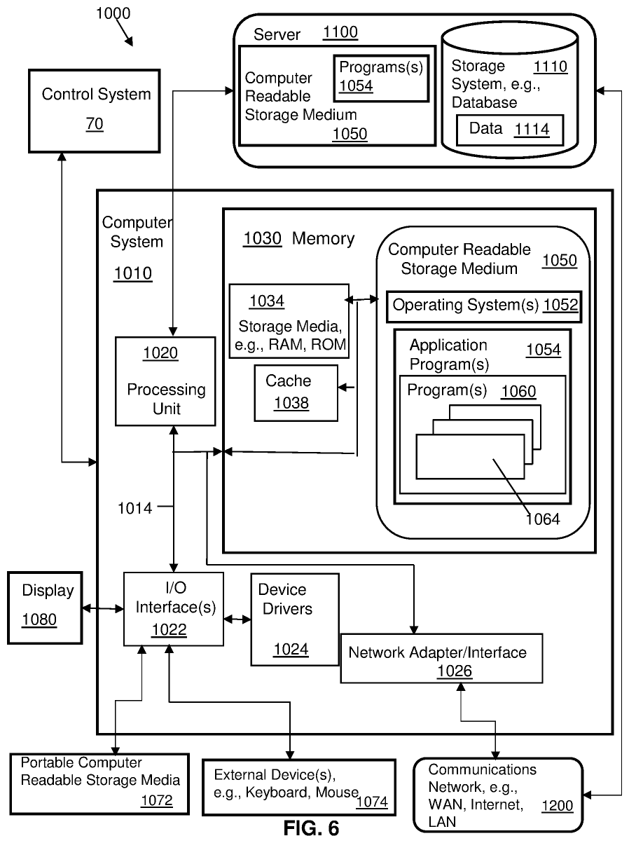

In the embodiment of the present disclosure shown in FIGS. 1 and 2, a computer can be part of a remote computer or a remote server, for example, remote server 1100 (FIG. 6). In another example, the computer 72 can be part of a control system 70 and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the mobile device can include a computer 30 having a processor 32 and a storage medium 34 which stores an application 40. The application can incorporate program instructions for executing the features of the present disclosure using the processor 32. In another example, the mobile device application or computer software can have program instructions executable for a front end of a software application incorporating the features of the method of the present disclosure in program instructions, while a back end program or programs 74, of the software application, stored on the computer 72 of the control system 70 communicates with the mobile device computer and executes other features of the method. The control system 70 and the mobile device or computer 30 can communicate using a communications network 50, for example, the Internet.

Thereby, the method 100 according to an embodiment of the present disclosure, can be incorporated in one or more computer programs or an application 40 stored on an electronic storage medium 34, and executable by the processor 32, as part of the computer on the mobile device. For example, a mobile device can communicate with the control system 70, and in another example, a device such as a video feed device can communicate directly with the control system 70. Other users (not shown) may have similar mobile devices which communicate with the control system similarly. The application can be stored, all or in part, on a computer or a computer in a mobile device and at a control system communicating with the mobile device, for example, using the communications network 50, such as the Internet. It is envisioned that the application can access all or part of program instructions to implement the method of the present disclosure. The program or application can communicate with a remote computer system via a communications network 50 (e.g., the Internet) and access data, and cooperate with program(s) stored on the remote computer system. Such interactions and mechanisms are described in further detail herein and referred to regarding components of a computer system, such as computer readable storage media, which are shown in one embodiment in FIG. 6 and described in more detail in regards thereto referring to one or more computer systems 1010.

Thus, in one example, a control system 70 is in communication with the computer 30, and the computer can include the application or software 40. The computer 30, or a computer in a mobile device (not shown) communicates with the control system 70 using the communications network 50.

In another example, the control system 70 can have a front-end computer belonging to one or more users, and a back-end computer embodied as the control system.

Also, referring to FIG. 1, a device can include a computer 30, computer readable storage medium 34, and operating systems, and/or programs, and/or a software application 40, which can include program instructions executable using a processor 32. These features are shown herein in FIG. 1, and also in an embodiment of a computer system shown in FIG. 6 referring to one or more computer systems 1010, which may include one or more generic computer components.

The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Specifically, regarding the control system 70, the device(s) 25, in one example the devices which can belong to one or more users, and can be in communication with the control system 70 via the communications network 50. In the embodiment of the control system shown in FIG. 1, the control system 70 includes a computer 72 having a database 76 and one or more programs 74 stored on a computer readable storage medium 73. In the embodiment of the disclosure shown in FIG. 1, the devices 25 communicate with the control system 70 and the one or more programs 74 stored on a computer readable storage medium 73. The control system includes the computer 72 having a processor 75, which also has access to the database 76.

The control system 70 can include a storage medium 80 for maintaining a registration 82 of users and their devices for analysis of the audio input. Such registration can include user profiles 83, which can include user data supplied by the users in reference to registering and setting-up an account. In an embodiment, the method and system which incorporates the present disclosure includes the control system (generally referred to as the back-end) in combination and cooperation with a front end of the method and system, which can be the application 40. In one example, the application 40 is stored on a device, for example, a computer on location 30, and can access data and additional programs at a back end of the application, e.g., control system 70.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, as in the example shown in FIG. 1 of a device and computer 30 having the application 40. The application 40 is stored on the computer 30 and can access data and additional programs at the back end of the application, for example, in the program(s) 74 stored in the control system 70.

The program(s) 74 can include, all or in part, a series of executable steps for implementing the method of the present disclosure. A program, incorporating the present method, can be all or in part stored in the computer readable storage medium on the control system or, in all or in part, on a computer 30 or device. It is envisioned that the control system 70 can not only store the profile of users, but in one embodiment, can interact with a website for viewing on a display of a device such as a mobile device, or in another example the Internet, and receive user input related to the method and system of the present disclosure. It is understood that FIG. 1 depicts one or more profiles 83, however, the method can include multiple profiles, users, registrations, etc. It is envisioned that a plurality of users or a group of users can register and provide profiles using the control system for use according to the method and system of the present disclosure.

### Still Further Embodiments and Examples

It is understood that the features shown in some of the FIGS., for example block diagrams, are functional representations of features of the present disclosure. Such features are shown in embodiments of the systems and methods of the present disclosure for illustrative purposes to clarify the functionality of features of the present disclosure.

The methods and systems of the present disclosure can include a series of operation blocks for implementing one or more embodiments according to the present disclosure. In some examples, operational blocks of one or more FIGS. may be similar to operational blocks another FIG. A method shown in one FIG. may be another example embodiment which can include aspects/operations shown in another FIG. and discussed previously.

### Additional Embodiments and Examples

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

In one example, Artificial Intelligence (AI) can be used, all or in part, for a learning model for analyzing data associated with items and assets.

In another example, the control system 70 can be all or part of an Artificial Intelligence (AI) system. For example, the control system can be one or more components of an AI system.

It is also understood that the method 100 according to an embodiment of the present disclosure, can be incorporated into (Artificial Intelligence) AI devices, which can communicate with respective AI systems, and respective AI system platforms. Thereby, such programs or an application incorporating the method of the present disclosure, as discussed above, can be part of an AI system. In one embodiment according to the present invention, it is envisioned that the control system can communicate with an AI system, or in another example can be part of an AI system. The control system can also represent a software application having a front-end user part and a back-end part providing functionality, which can in one or more examples, interact with, encompass, or be part of larger systems, such as an AI system. In one example, an AI device can be associated with an AI system, which can be all or in part, a control system and/or a content delivery system, and be remote from an AI device. Such an AI system can be represented by one or more servers storing programs on computer readable medium which can communicate with one or more AI devices. The AI system can communicate with the control system, and in one or more embodiments, the control system can be all or part of the AI system or vice versa.

It is understood that as discussed herein, a download or downloadable data can be initiated using a voice command or using a mouse, touch screen, etc. In such examples a mobile device can be user initiated, or an AI device can be used with consent and permission of users. Other examples of AI devices include devices which include a microphone, speaker, and can access a cellular network or mobile network, a communications network, or the Internet, for example, a vehicle having a computer and having cellular or satellite communications, or in another example, IoT (Internet of Things) devices, such as appliances, having cellular network or Internet access.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Further Additional Examples and Embodiments

Referring to FIG. 6, an embodiment of system or computer environment 1000, according to the present disclosure, includes a computer system 1010 shown in the form of a generic computing device. The method 100, for example, may be embodied in a program 1060, including program instructions, embodied on a computer readable storage device, or a computer readable storage medium, for example, generally referred to as computer memory 1030 and more specifically, computer readable storage medium 1050. Such memory and/or computer readable storage media includes non-volatile memory or non-volatile storage, also known and referred to non-transient computer readable storage media, or non-transitory computer readable storage media. For example, such non-volatile memory can also be disk storage devices, including one or more hard drives. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, the system or computer environment 1000 includes the computer system 1010 shown in the form of a general-purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that a control system 70, communicating with a computer system, can include all or part of the computer system 1010 and its components, and/or the control system can communicate with all or part of the computer system 1010 and its components as a remote computer system, to achieve the control system functions described in the present disclosure. The control system function, for example, can include storing, processing, and executing software instructions to perform the functions of the present disclosure. It is also understood that the one or more computers or computer systems shown in FIG. 1 similarly can include all or part of the computer system 1010 and its components, and/or the one or more computers can communicate with all or part of the computer system 1010 and its components as a remote computer system, to achieve the computer functions described in the present disclosure.

In an embodiment according to the present disclosure, one or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions. For example, in one embedment according to the present disclosure, a program embodying a method is embodied in, or encoded in, a computer readable storage medium, which includes and is defined as, a non-transient or non-transitory computer readable storage medium. Thus, embodiments or examples according to the present disclosure, of a computer readable storage medium do not include a signal, and embodiments can include one or more non-transient or non-transitory computer readable storage mediums. Thereby, in one example, a program can be recorded on a computer readable storage medium and become structurally and functionally interrelated to the medium.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

### Still Further Additional Examples and Embodiments

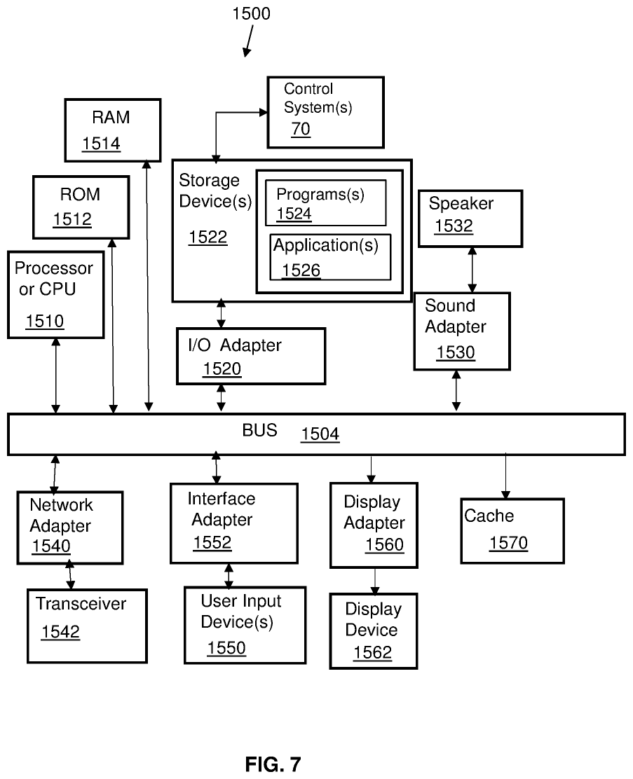

Referring to FIG. 7, an example system 1500 for use with the embodiments of the present disclosure is depicted. The system 1500 includes a plurality of components and elements connected via a system bus 1504 (also referred to as a bus). At least one processor (CPU) 1510, is connected to other components via the system bus 1504. A cache 1570, a Read Only Memory (ROM) 1512, a Random Access Memory (RAM) 1514, an input/output (I/O) adapter 1520, a sound adapter 1530, a network adapter 1540, a user interface adapter 1552, a display adapter 1560 and a display device 1562, are also operatively coupled to the system bus 1504 of the system 1500.

One or more storage devices 1522 are operatively coupled to the system bus 1504 by the I/O adapter 1520. The storage device 1522, for example, can be any of a disk storage device (e.g., a magnetic or optical disk storage device), a solid state magnetic device, and so forth. The storage device 1522 can be the same type of storage device or different types of storage devices. The storage device can include, for example, but not limited to, a hard drive or flash memory and be used to store one or more programs 1524 or applications 1526. The programs and applications are shown as generic components and are executable using the processor 1510. The program 1524 and/or application 1526 can include all of, or part of, programs or applications discussed in the present disclosure, as well vice versa, that is, the program 1524 and the application 1526 can be part of other applications or program discussed in the present disclosure. The storage device can communicate with the control system 70 which has various functions as described in the present disclosure.

A speaker 1532 is operatively coupled to system bus 1504 by the sound adapter 1530. A transceiver 1542 is operatively coupled to system bus 1504 by the network adapter 1540. A display 1562 is operatively coupled to the system bus 1504 by the display adapter 1560.

One or more user input devices 1550 are operatively coupled to the system bus 1504 by the user interface adapter 1552. The user input devices 1550 can be, for example, any of a keyboard, a mouse, a keypad, an image capture device, a motion sensing device, a microphone, a device incorporating the functionality of at least two of the preceding devices, and so forth. Other types of input devices can also be used, while maintaining the spirit of the present invention. The user input devices 1550 can be the same type of user input device or different types of user input devices. The user input devices 1550 are used to input and output information to and from the system 1500.

### Other Aspects and Examples

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### ADDITIONAL ASPECTS AND EXAMPLES

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

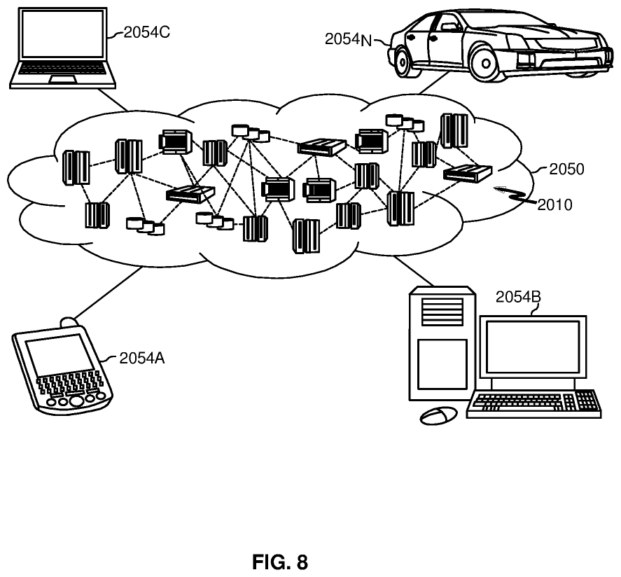

Referring now to FIG. 8, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 8 are intended to be illustrative only and that computing nodes 2010 and cloud computing environment 2050 can communicate with any type of computerized device over any type of network and/or network addressable connection (e.g., using a web browser).

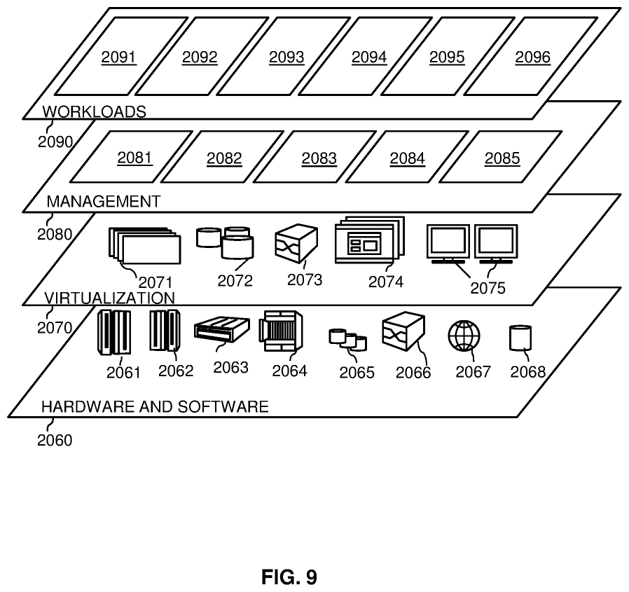

Referring now to FIG. 9, a set of functional abstraction layers provided by cloud computing environment 2050 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and automatically detecting and cataloging or inventorying items or assets at a location or property 2096.

What is claimed is:

1. A computer-implemented method for automatically detecting and cataloging items or assets at a location or property, comprising:
capturing, using a computer and using multiple techniques and corresponding devices, data about an item of a plurality of items in a defined location, for cataloging the item;
determining, using the computer, when the data meets threshold criteria for identification of the item and completing an identification of the item when the data meets the threshold criteria;
determining when the item meets asset criteria for being cataloged as an asset, in response to the item meeting the threshold criteria for identification of the item and thereby the identification being completed;
gathering metadata about the asset, in response to meeting the asset criteria; and
cataloging the asset with the data and the metadata.

2. The method of claim 1, wherein the threshold criteria including determining an identification of the item using the data.

3. The method of claim 1, wherein the threshold criteria includes a threshold probability of an identification of the item using the data; and
the identification occurring in response to the threshold criteria being met based on the threshold probability being met.

4. The method of claim 1, further comprising:
searching for and gathering the data and the metadata using a communications network; and wherein the searching for and the gathering the data and the metadata includes searching archive data and public data.

5. The method of claim 1, further including:
reading a blockchain for the identified item to gather metadata about the identified item.

6. The method of claim 1, wherein the data includes a data input selected from a group consisting of: a video feed, a photo, manual entry including a keyboard input or a voice command audio input, as the multiple techniques and the corresponding devices.

7. The method of claim 1, wherein the multiple techniques and corresponding devices are selected from a group consisting of: video feeds, cameras, network inventory using network login, network inventory using Internet of Things (IoT), and computerized purchasing history.

8. The method of claim 1, wherein the asset criteria includes a valuation of the item and a threshold asset value.

9. The method of claim 1, further comprising:
initiating other capturing techniques in response to the threshold criteria not being met.

10. The method of claim 1, further comprising:
initiating another capturing technique for capturing the data about the item, in response to the data not meeting the threshold criteria.

11. The method of claim 10, wherein the threshold criteria not being met includes being unable to identify the item.

12. The method of claim 1, further comprising:
iteratively using another capturing technique until the data meets the threshold criteria for the identification of the item.

13. The method of claim 1, wherein the assets are physical and/or digital.

14. The method of claim 1, further comprising:
assessing when an identified item is currently cataloged; and
adding the metadata to the catalog about the currently cataloged identified item or the asset.

15. The method of claim 1, further comprising:
assessing when an identified item is currently cataloged; and
determining whether to add the identified item, in response to the identified item being currently cataloged.

16. The method of claim 1, further comprising:
assessing a value of the asset using data and the metadata of the cataloged item or asset.

17. The method of claim 1, further comprising:
detecting the item entering the defined location;
determining when the item meets the asset criteria by determining when an item meets a threshold value and thereby is an asset, in response to the identification of the item;
initiating the gathering of metadata, in response to the determining that the item meets the asset criteria for being cataloged as an asset.

18. The method of claim 17, wherein the threshold value includes determining when the item meets a minimal value.

19. The method of claim 18, wherein the determining when the item meets a minimal value includes checking a list of item categories for items meeting the asset criteria, and further comprises:
receiving, at the computer, the list from a user; and
cataloging the item as an asset, in response to the item matching a category in the list.

20. The method of claim 18, wherein the minimal value to the item can be sentimental or monetary.

21. The method of claim 1, further comprising:
sending a communication to a user including an identified asset before the cataloging of the asset; and
receiving authorization from the user to catalog the identified asset.

22. The method of claim 1, further comprising:
sending a communication to a user which includes a first identified item or a first asset; and
receiving notification from the user to mark or add an entry in the catalog as metadata about the first identified item or the first asset.

23. The method of claim 22, further comprising:
receiving notification from the user to mark or add an entry in the catalog regarding the first identified item or the first asset as borrowed or as a temporary asset.

24. A system using a computer for automatically detecting and cataloging items or assets at a location or property, which comprises:
a computer system comprising; a computer processor, a computer-readable storage medium, and program instructions stored on the computer-readable storage medium being executable by the processor, to cause the computer system to perform the following functions to;
capture, using a computer and using multiple techniques and corresponding devices, data about an item of a plurality of items in a defined location, for cataloging the item;
determine, using the computer, when the data meets threshold criteria for identification of the item and completing an identification of the item when the data meets the threshold criteria;
determine when the item meets asset criteria for being cataloged as an asset, in response to the item meeting the threshold criteria for identification of the item and thereby the identification being completed;
gather metadata about the asset, in response to meeting the asset criteria; and
catalog the asset with the data and the metadata.

25. A computer program product for automatically detecting and cataloging items or assets at a location or property, the computer program product comprising a computer readable storage medium having program instructions embodied therewith, the program instructions executable by a computer to cause the computer to perform functions, by the computer, comprising the functions to:
capture, using a computer and using multiple techniques and corresponding devices, data about an item of a plurality of items in a defined location, for cataloging the item;
determine, using the computer, when the data meets threshold criteria for identification of the item and completing an identification of the item when the data meets the threshold criteria;
determine when the item meets asset criteria for being cataloged as an asset, in response to the item meeting the threshold criteria for identification of the item and thereby the identification being completed;
gather metadata about the asset, in response to meeting the asset criteria; and
catalog the asset with the data and the metadata.
